(19) United States
(12) Patent Application Publication
(10) Pub. No.: US 2003/0197160 A1
(43) Pub. Date: Oct. 23, 2003

(54) Reduced pull chain drive for roll-up doors

(76) Inventor: David B. Curtis, Villa Rica, GA (US)

Correspondence Address: Jason A. Bernstein, BERNSTEIN & ASSOCIATES, P.C., Embassy Row 400, Suite 495, 6600 Peachtree Dunwoody Road, N.E., Atlanta, GA, 30328-1649, US

(21) Appl. No.: 10/127,881

(22) Filed: Apr. 23, 2002

(51) Int. Cl. B66D 3/16

(52) U.S. Cl. 254/358

(57) ABSTRACT

A reduced pull chain hoist comprising a frame having a pair of bearings for receiving a hexagonal shaft, a chain guide, a chain pocket wheel for turning a chain and a spur gear. A conventional curtain roll-up door is operated by pulling the chain which turns the chain pocket wheel, shaft and spur gear. The spur gear engages a ring gear mounted to a drum assembly. As the spur gear turns the ring gear and drum assembly and causes the door to raise or lower.

### FIELD OF THE INVENTION

The present invention relates to reduced pull chain drives and, more particularly, to a reduction gear chain hoist.

### BACKGROUND OF THE INVENTION

Reduction gear chain hoists are used to raise and lower roll-up curtain doors, which conventionally are too heavy to be repeatedly raised and lowered by hand. Conventional reduction gear chain hoists use a roller chain and sprocket assembly. Installation of the assembly takes considerable time and adjustment of the components is cumbersome. It would be desirable to have a chain hoist that is easily and quickly installed and aligned and which requires less maintenance than conventional hoists.

### SUMMARY OF THE INVENTION

The present invention provides a reduction gear chain hoist comprising a frame assembly, a chain guide assembly, chain pull assembly, a drive gear and shaft assembly, and a mounting assembly. The frame assembly comprises a frame box having two bearings mounted therein in axial alignment. A support plate having a pair of chain guides is mounted to the frame. The chain pull assembly comprises a chain pocket wheel and a pull chain. The drive gear and shaft assembly comprises a hexagonal shaft which at one side passes through the frame bearings and the chain pocket wheel, which are retained by a retaining ring spring fitted in a groove at the end of the shaft. The other end of the shaft passes through a spur gear and has a second retaining ring held in place by being spring fitted in a second groove at this end of the shaft. A ring gear and drum assembly comprises a ring gear with internal perimeter teeth. The ring gear is mounted to a drum, which in turn is mounted to the door assembly. An axle passes through the drum and the ring gear. A mounting bracket and associated hardware mount the chain hoist to the door frame or wall.

A chain clip can be mounted separately to the wall to retain the chain and prevent the door assembly from being turned. A head stop can be inserted in a slot in the mounting bracket.

In an alternative embodiment the chain pocket wheel and chain guide can be replaced with a sprocket, chain and motor for electric control of the door movement.

Other features and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the figures of which:

FIG. 1 is a perspective view of a first embodiment of the present invention.

FIG. 2 is an exploded perspective view of the first embodiment.

FIG. 3 is an exploded perspective view of the frame assembly.

FIG. 4 is a perspective view of the frame assembly when assembled.

FIG. 5 is an exploded perspective view of the chain drive, frame and drive shaft assemblies.

FIG. 6 is an exploded perspective view of the chain drive assembly and mounting bracket.

FIG. 7 is an exploded perspective view of the drive shaft assembly.

FIG. 8 is a perspective view of the drive shaft assembly when assembled.

FIG. 9 is an exploded perspective view of the ring gear and drum assembly.

FIG. 10 is a perspective view of the ring gear an drum assembly when assembled.

FIG. 11 is a perspective view of a second embodiment of the present invention.

FIG. 12 is a detail side elevational view of the sprocket, frame and spur gear components as assembled.

### DETAILED DESCRIPTION OF THE INVENTION

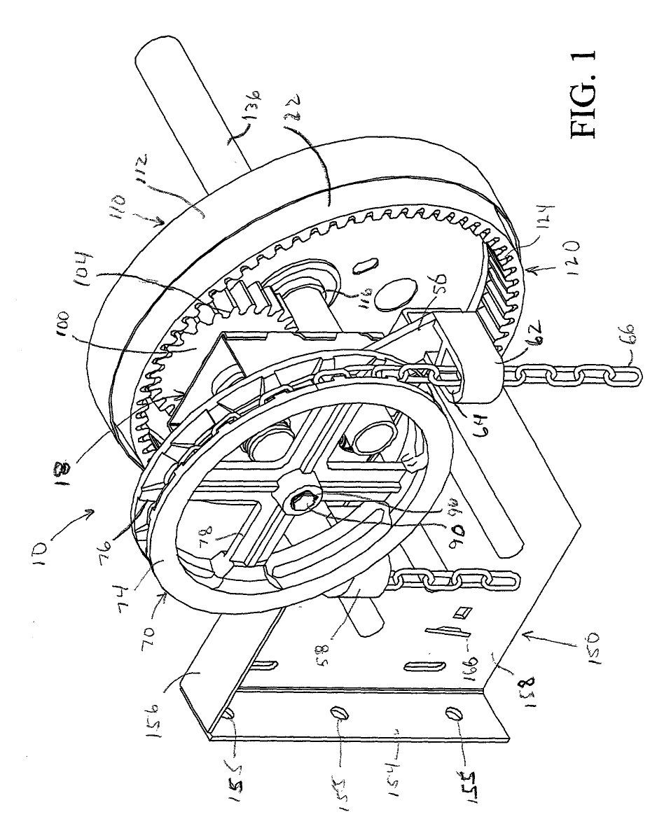

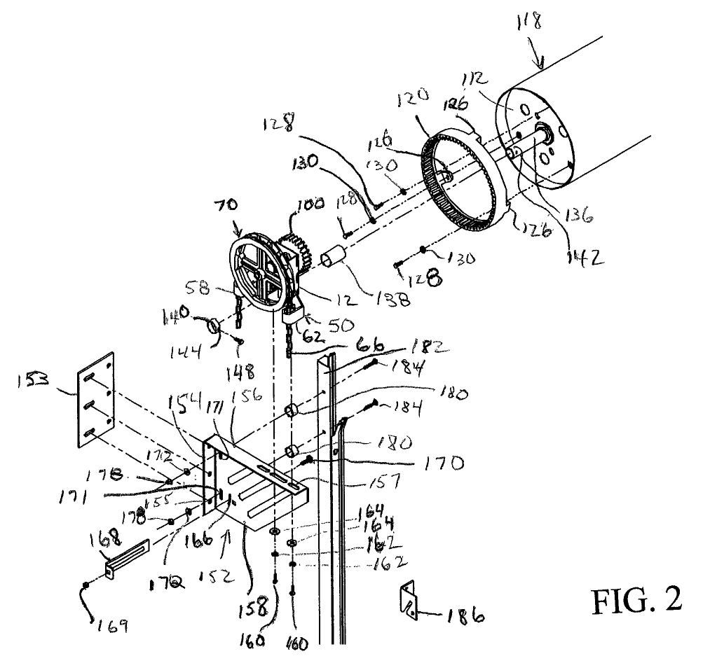

FIGS. 1-2 illustrate one embodiment of a chain hoist 10 of the present invention. The main assemblies comprise a frame assembly 12, a chain guide assembly 14, a drive shaft assembly 16, a chain pocket wheel 70 and a spur gear 100. The chain hoist 10 of the present invention is designed to be mountable on either side of the door assembly by rearranging the components during installation. For the purposes of the present disclosure, the present invention is described as it would be installed on the left side of the door assembly, when viewed facing the door curtain and the door assembly and the tensioner is on the viewer's right side of the door frame. A different mounting bracket (as discussed in greater detail hereinbelow) would be used, i.e., a left hand versus a right hand bracket, depending on which side of the door frame the chain hoist is to be mounted.

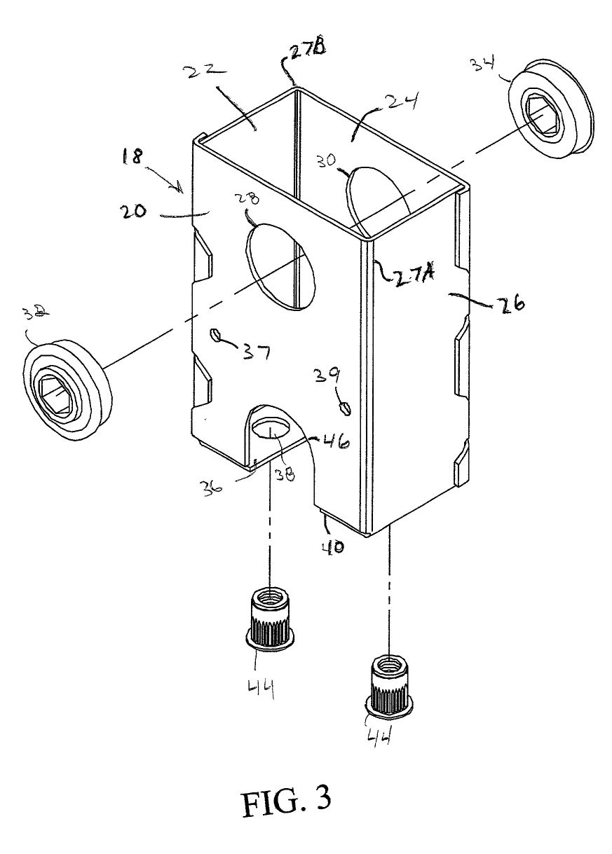

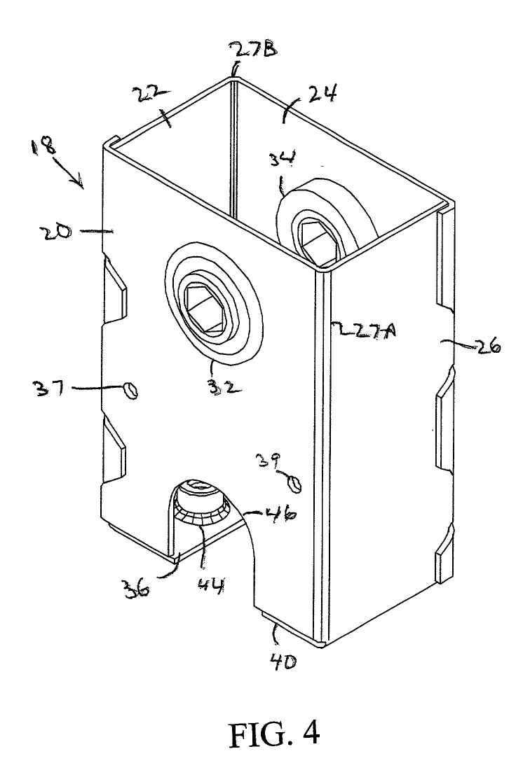

FIGS. 3-4 show the frame assembly 12, which comprises a generally open rectangular frame 18 structure defined by a set of walls 20, 22, 24 and 26. It is to be understood that other shapes and geometries are possible and that the structure can be more closed or solid. In one construction the walls 20 and 26 are formed from a right angle section 27A and the walls 22 and 24 are formed from a second right angle section 27B arranged to form an open box when the sections 27A, B are attached to each other. An open shape as shown is preferable because of the lighter weight and lower manufacturing cost compared to more closed or solid structure. The frame 18 has an aperture 28 and an aperture 30 defined in opposing parallel walls 20 and 24, respectively. A bearing 32 is sized to be mounted in the aperture 28 and a bearing 34 is sized to be mounted in the aperture 30. The bearings 32 and 34 preferably, though not mandatorily, have a hexagonal bore therethrough for receiving a drive shaft assembly 16. Alternatively, it is possible that a single bearing 32 can be used and mounted between the walls 20 and 24.

The wall 20 can have at least one, and preferably has two apertures for receiving a fastener, such as, but not limited to, a bolt, screw or the like. The frame 18 has a first bottom portion 36 having an aperture 38 and a second bottom portion 40, which has an aperture 42 (not shown). The apertures 38 and 42 can each receive a nut insert 44. The nut insert can receive a mounting bolt, as will be described in greater detail hereinbelow. Alternatively, rather than nut inserts, the first and second bottom portion apertures 38 and 42 can be sufficiently thick to be threaded and receive the mounting bolt. Or, a nut (not shown) can be threaded onto the bolt. A notch 46 is cut out of the walls 20 and 24 to receive a door axle.

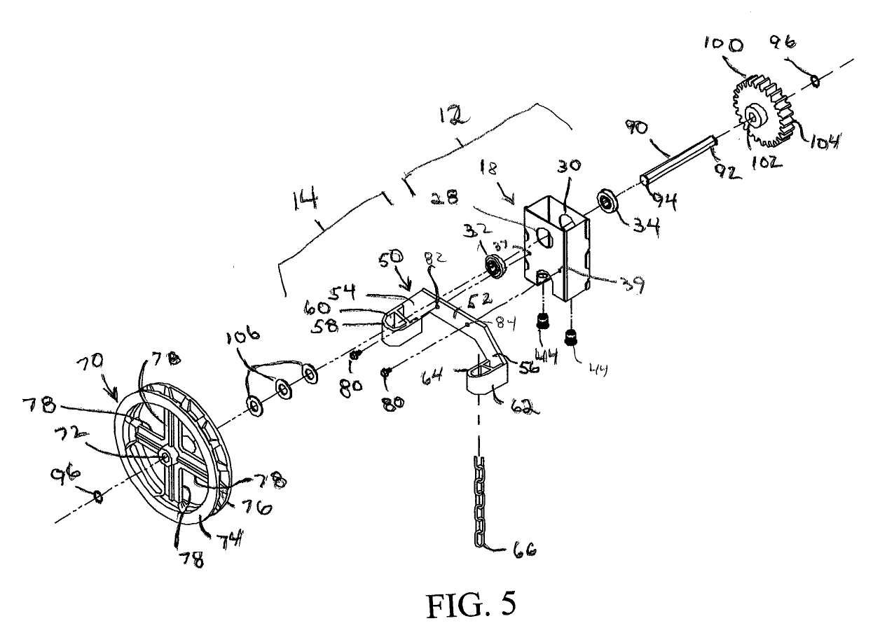

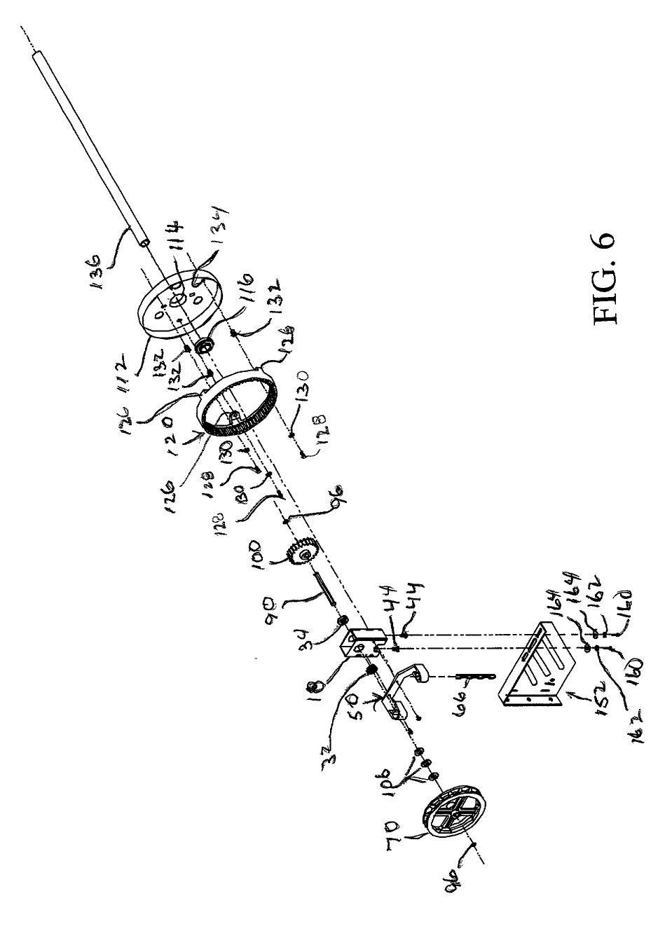

The chain guide assembly 14, shown in FIGS. 5-6, comprises a support plate 50 having a middle section 52, a first end portion 54 and a second end portion 56, the first and second end portions 54, 56 preferably extending angularly outward in a generally “C” shaped manner. A first chain guide 58 having a guide or channel 60 extends perpendicularly from the first end portion 54 and a second chain guide 62 having a channel 64 extends perpendicularly from the second end portion 56. The chain guides 58 and 62 can be formed of the same structure as the support plate 50. The chain guides 58 and 62 can accommodate a length of chain 66 passing therethrough. It is to be understood that the main purpose of the support plate 50 is to maintain the chain guides 58 and 62 in a spaced apart relationship. Therefore, other shapes and configurations of the support plate and chain guides is contemplated as being within the scope of the present invention. It is also possible for the support plate 50 and frame 18 to be formed from the same piece of material.

A chain pocket wheel 70 has a bore 72 and a rim 74 having a series of protruding teeth 76 or pockets for engaging the chain 66. The wheel 70 can have a plurality of spokes 78 connecting the bore 72 to the rim 74. Alternatively, the wheel 70 can be a closed structure with the bore 72 passing therethrough. The support plate 50 attaches to the frame 18 by at least one, and preferably a plurality of screws or bolts 80 passing through apertures 82, 84 in the support plate 50 and the apertures 37, 39 in the frame 18. As noted previously, the support plate 50 can be formed as part of the frame 18.

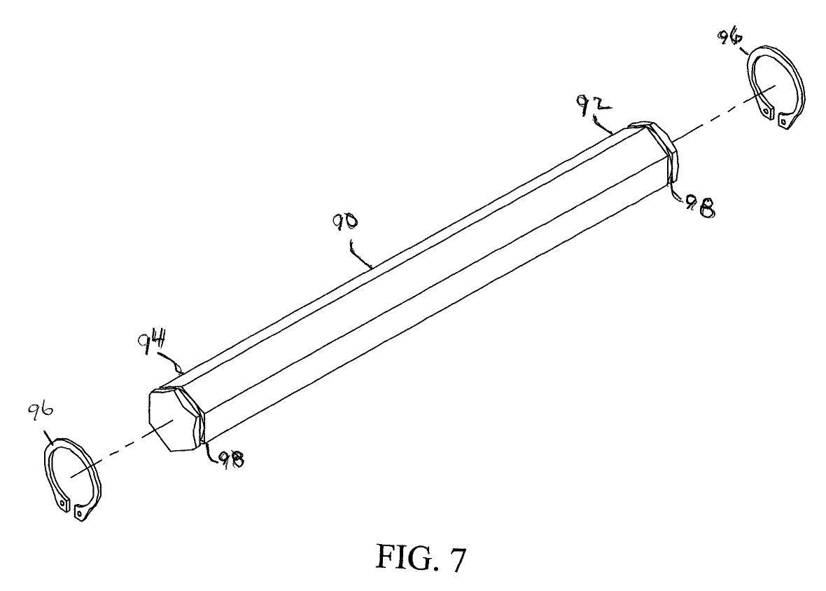

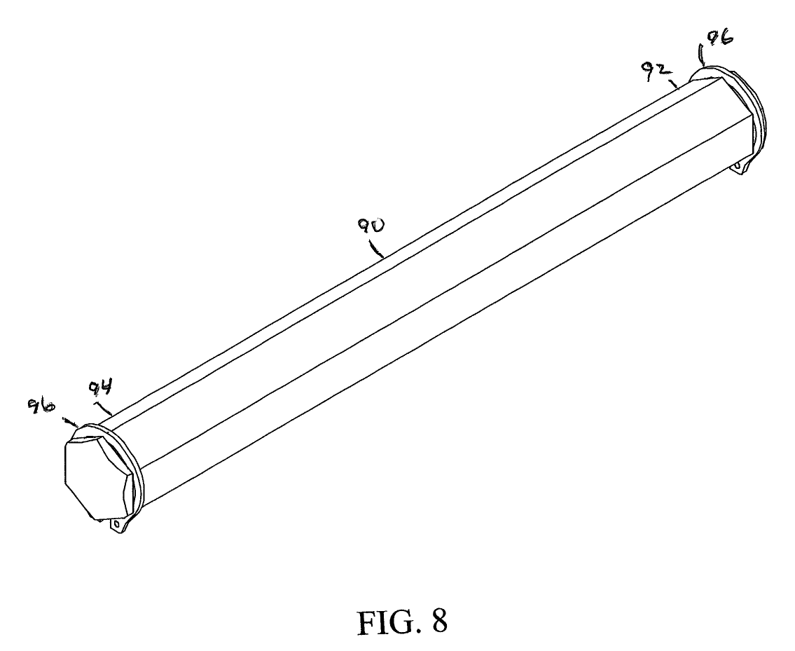

FIGS. 7-8 show the drive shaft assembly 16, which comprises a shaft 90, which is preferably hexagonal in cross-section. It is to be understood that other cross-sectional shapes can be used, such as, but not limited to, octagonal, square, pentagonal, circular, and the like. Additionally, the shaft 90 can be circular in cross-section and have a key way cut axially therein to provide a gripping surface for turning the shaft 90. The shaft 90 has a first end 92 and a second end 94. Each end has a retaining device associated therewith for use when the drive shaft assembly 16 is installed. In one embodiment, the retaining device is a retaining clip 96, which can comprise an open nearly circular shape capable of flexing enough to slip over the shaft 90 and engage the shaft 90 in an annular groove 98 proximate to each end 92 and 94. Alternatively, the retaining device can be a pin, such as a cotter pin or other retaining device which can pass through an aperture in the ends 92 and 94. The purpose of the retaining device is to prevent components through which the shaft 90 is passed from sliding off the end of the shaft 90.

FIGS. 5-6 show a spur gear 100 having bore 102 and a plurality of teeth 104. The bore slidingly receives one end of the shaft 90. The shaft 90 passes through the frame 18 bearings 32 and 34 and through the chain pocket wheel 70 bore 72. Preferably, at least one spacer washer 106 is positioned on the shaft 90 between the chain pocket wheel 70 and the bearing 32.

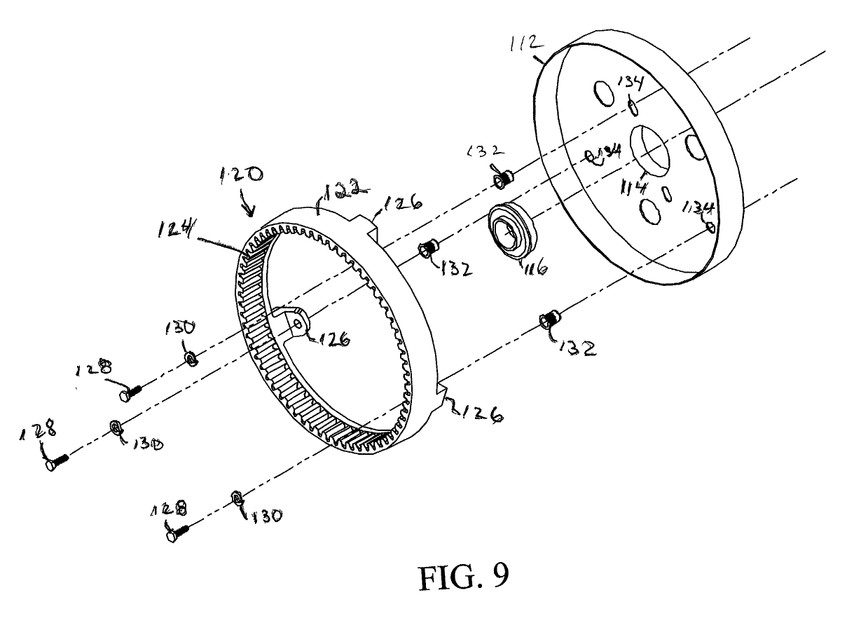

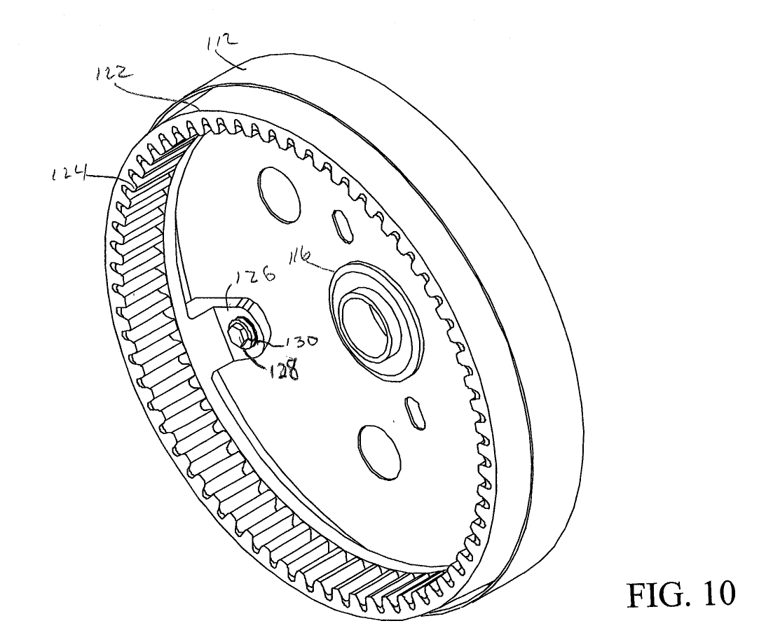

FIGS. 9-10 show a conventional drum and ring gear assembly 110 comprising a drum 112 having a plurality of apertures and a central bore 114 into which a bearing 116 is fitted. The drum 112 is associated with a conventional door assembly 118, shown in part in FIG. 2. A ring gear 120 comprises a ring 122 having a plurality of teeth 124 disposed on the inner periphery of the ring 122. It is also possible for the ring gear to have the teeth 124 on the outside of the ring 124. The teeth 124 engage the spur gear teeth 104 when the chain hoist 10 is assembled. At least one, and preferably a plurality of mounting ears 126 extend from the edge of the ring 122. The ears 126 mount to the drum 112 by means of fasteners, such as, but not limited to, bolts 128, lockwashers 130 and nut inserts 132, which mount to a set of apertures 134 in the drum, the bolts 128 passing through the ears 126. FIGS. 2 and 6 show an axle 136 passing through the bearing 116. Preferably, a spacer 138 slides over the axle 136 and preferably a collar 140 slides over the end 142 of the axle 136. The collar 140 can have an aperture 144 disposed therein and a self-drilling screw 148 inserted through the aperture 144 and partially into the axle 136 to maintain the collar 140 in a fixed position with respect to the axle 136. The axle 136 passes through the notches 46 of the frame 18.

FIG. 2 shows the assembled chain hoist 10 as mounted to a conventional door mounting bracket assembly 150, which comprises a bracket 152 having a vertical section 154, a horizontal section 156 and a support panel 158. Different designs of the mounting bracket 152 are available. In one configuration, the vertical section 154 has a plurality of apertures 155 for receiving bolts (not shown) to mount to a mounting plate 153 associated with a door, frame or wall. The horizontal section 156 has a plurality of apertures 157, which preferably are slots to permit adjustment of the position of bolts 160 passing therethrough which are threaded into the nut inserts 44 of the frame 18. Optionally, lockwashers 162 and/or flat washers 164 can be used. Preferably, there is at least one slot 166 disposed in the support panel 158 which can slidingly receive a head stop 168, as is known in the art to prevent the door from over traveling. The head stop 168 is held in place by a bolt 170 and nut 169. At least one bolt 184 passes through at least one aperture 171 defined in the support panel 158 and can have a flat washer 172 mounted thereon as well as a nut 178. Optionally, spacers 180 can be mounted on the bolt 184 and between a conventional door guide 182 and the support panel 158. An optional chain clip 186 can be mounted to the door frame or wall to hold the chain 66. Optionally, the chain clip may have an aperture for receiving a lock, such as a padlock, for locking the chain, and thus, the door, in an open or closed position.

When installed with a conventional roll-up door curtain and door assembly, the chain hoist of the present invention operates as follows. When a user pulls on the chain 66, the pocket wheel 70 teeth 76 engage the chain 66 links, causing the pocket wheel 70 to rotate. The rotational torque is passed to the shaft 90, which causes the spur gear teeth 104 to engage the ring gear teeth 124 and turn the ring gear 120, which in turn causes the drum 112 to rotate. As the drum 112 rotates the door curtain (not shown) is raised or lowered.

An advantage of the present invention is that it is a gear reduction chain hoist that is easy and quick to install and requires less maintenance than conventional roller chain and sprocket hoists. It is easier to install because minimal adjustment is required during installation compared to conventional chain hoists. Also, there is no roller chain which can stretch, wear or become misaligned over time. The present invention also obviates the need to periodically lubricate a roller chain. The chain hoist of the present invention can also be used on either side of a door assembly by assembling the parts substantially in mirror image.

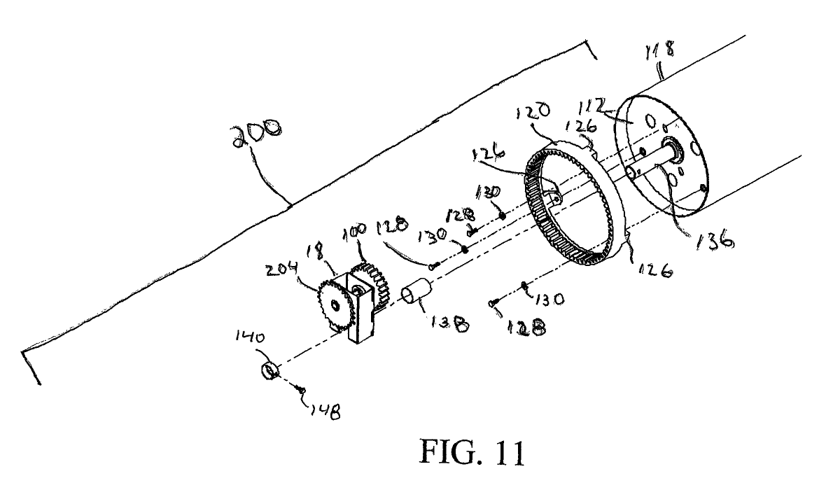

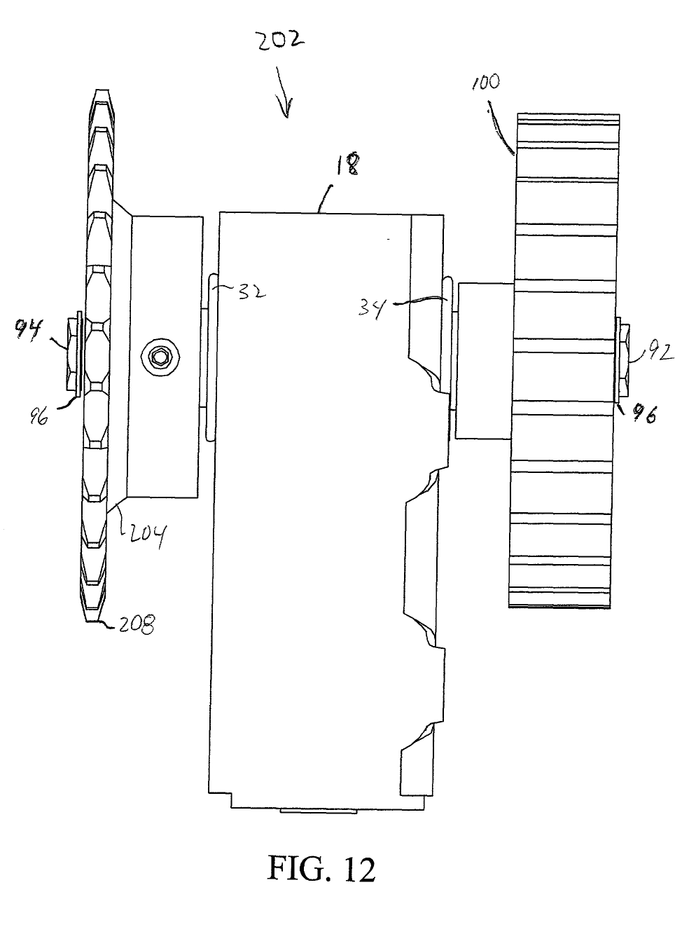

In a second embodiment of the present invention, shown in FIGS. 11-12, an electric operation hoist 200 has generally the same components as the first embodiment, with the exception that the chain 66, chain pocket wheel 70, and chain guide assembly 14, which are typically manually operated, can be substituted with a motor driven sprocket drive assembly 202. The sprocket drive assembly 202 has a sprocket 204 having a bore 206 (not shown) and teeth 208. The shaft 90 is received through the bore 206 and retained using the retaining clip 96. FIG. 12 shows the sprocket 204 assembled with the frame 18 and the spur gear 100. In this embodiment, the chain guide assembly 14, chain pocket wheel 70 and chain 66 are not used. In operation a conventional roller chain 210 (not shown) (or other chain or drive belt) is operatively associated with the sprocket 204 and a conventional chain drive motor 212 (not shown). The motor 212 can be actuated by switch or sensor 214 (not shown) and cause the roller chain 210 to turn the sprocket 204, which causes the spur gear 100 to turn, which causes the ring gear 120 and door assembly 118 to turn, thus raising or lowering the door curtain (not shown).

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

It should further be noted that any patents, applications and publications referred to herein are incorporated by reference in their entirety.

What is claimed is:

1. A chain hoist, comprising:
a) a frame assembly comprising
i) a housing,
ii) at least one bearing aperture,
iii) at least one frame bearing mounted in said at least one bearing aperture, and
iv) at least one aperture for receiving at least one fastening means;
b) a chain guide assembly comprising
i) a support plate having a first end and a second end, said support plate being mounted to said frame assembly housing,
ii) a first guide section having at least one first guide defined therein for receiving a chain, said first guide section associated with said support plate first end,
iii) a second guide section having at least one second guide defined therein for receiving a chain, said second guide section associated with said support plate second end;
c) a chain pocket wheel;
d) a spur gear;
e) a ring gear having
i) a plurality of teeth disposed on the periphery of said ring gear and
ii) a means for mounting said ring gear to a drum; and,
f) a drive shaft assembly comprising
i) a drive shaft having a first end and a second end,
ii) at least one retaining means removably associated with said first end, and
iii) at least one retaining means removably associated with said second end
said drive shaft passing through said spur gear aperture, said at least one frame assembly bearing and said chain pocket wheel.

2. The chain hoist of claim 1, further comprising a mounting bracket for mounting said frame assembly to a door frame.

3. The chain hoist of claim 1, wherein said drive shaft has a cross-sectional shape having at least three sides.

4. The chain hoist of claim 1, wherein said drive shaft has a hexagonal cross-sectional shape.

5. The chain hoist of claim 1, further comprising a drum associated with said ring gear.

6. The chain hoist of claim 1, further comprising a chain interactively engaging said chain pocket wheel.

7. The chain hoist of claim 1, wherein mounting means comprises a plurality of mounting tabs extending from said ring gear, each tab having an aperture defined therein for receiving a fastening means

8. A chain hoist, comprising:
a) a frame assembly comprising
i) a housing,
ii) at least one bearing aperture,
iii) at least one frame bearing mounted in said at least one bearing aperture, and
iv) at least one aperture for receiving at least one fastening means;
b) a chain guide assembly comprising
i) a support plate having a first end and a second end, said support plate being mounted to said frame assembly housing,
ii) a first guide section having at least one first guide defined therein for receiving a chain, said first guide section associated with said support plate first end,
iii) a second guide section having at least one second guide defined therein for receiving a chain, said second guide section associated with said support plate second end;
c) a chain pocket wheel;
d) a chain operatively engaging said chain pocket wheel;
e) a spur gear;
f) a ring gear having
i) a plurality of teeth disposed on the periphery of said ring gear and
ii) a plurality of mounting tabs extending from said ring gear, each tab having an aperture defined therein for receiving a fastening means; and,
g) a drive shaft assembly comprising
i) a hexagonal drive shaft having a first end and a second end,
ii) at least one retaining means removably associated with said first end, and
iii) at least one retaining means removably associated with said second end
said drive shaft passing through said spur gear aperture, said at least one frame assembly bearing and said chain pocket wheel.

9. A door hoist, comprising:
a) a frame assembly comprising
i) a housing,
ii) at least one aperture for receiving at least one bearing,
iii) at least one bearing mounted in said at least one aperture, and
iv) at least one aperture for receiving at least one fastening means;
b) a drive assembly comprising
i) a chain sprocket, and
ii) a drive motor for turning said chain sprocket;
iii) a drive chain operatively connecting said chain sprocket and said drive motor;
c) spur gear having an aperture defined therein;
d) a ring gear having
i) a plurality of teeth disposed on the inside periphery of said ring gear, and
ii) a plurality of mounting tabs; and,
e) a drive shaft assembly comprising
i) a drive shaft having a first end and a second end,
ii) at least one retaining means removably associated with said first end, and
iii) at least one retaining means removably associated with said second end said drive shaft passing through said spur gear aperture, said at least one frame assembly bearing and said chain sprocket.

10. The chain hoist of claim 9, further comprising a mounting bracket for mounting said frame assembly to a door frame.

11. The chain hoist of claim 9, wherein said drive shaft has a cross-sectional shape having at least three sides.

12. The chain hoist of claim 9, wherein said drive shaft has a hexagonal cross-sectional shape.

13. The chain hoist of claim 9, further comprising a drum associated with said ring gear.
